(19) United States
(12) Patent Application Publication
(10) Pub. No.: US 2024/0250838 A1
(43) Pub. Date: Jul. 25, 2024

(54) WEB CONFERENCE DATA VISUALIZATION

(71) Applicant: INTERNATIONAL BUSINESS MACHINES CORPORATION, ARMONK, NY (US)

(72) Inventors: Su Liu, Austin, TX (US); Adinarayana Haridas, Hyderabad (IN); Hamid Majdabadi, Ottowa (CA); Jun Su, Beijing (CN); Peng Hui Jiang, Beijing (CN)

(21) Appl. No.: 18/159,190

(22) Filed: Jan. 25, 2023

(51) Int. Cl. H04L 12/18; G06T 11/20

(52) U.S. Cl. CPC H04L 12/1822; G06T 11/206

(57) ABSTRACT

Aspects of the present disclosure relate to data visualization in web conferences. Type-related information of a web conference can be acquired. A conference type of the web conference can be identified based on the acquired type-related information of the web conference and type templates stored in a type repository. A visualization format from a plurality of visualization formats stored in a format repository can be determined based on the identified conference type. Key information required by the determined visualization format can be extracted from raw data of the web conference. Visual data within the determined visual format can be created by populating the extracted key information into the determined visualization format.

### BACKGROUND

The present disclosure relates generally to web conferences, and more specifically, to web conference data visualization.

Web conferencing software facilitates communication between individuals online via transmission of audio/video (A/V) data of the individuals in real-time over a network.

### SUMMARY

Embodiments of the present disclosure are directed to a method, system, and computer program product for data visualization management.

Type-related information of a web conference can be acquired. A conference type of the web conference can be identified based on the acquired type-related information of the web conference and type templates stored in a type repository. A visualization format from a plurality of visualization formats stored in a format repository can be determined based on the identified conference type. Key information required by the determined visualization format can be extracted from raw data of the web conference. Visual data within the determined visual format can be created by populating the extracted key information into the determined visualization format.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a high-level block diagram illustrating an example computer system and network environment that can be used in implementing one or more of the methods, tools, modules, and any related functions described herein, in accordance with embodiments of the present disclosure.

FIG. 2 is a block diagram illustrating an example computing environment in which illustrative embodiments of the present disclosure can be implemented.

FIG. 3 depicts an exemplary schematic diagram of visual data presentation in a web conference, in accordance with embodiments of the present disclosure.

FIG. 4 depicts an exemplary schematic diagram of extracting key information from raw data of a web conference, in accordance with embodiments of the present disclosure.

FIG. 5A and FIG. 5B depict exemplary schematic diagrams of visual data created with different visualization formats in a given web conference, in accordance with embodiments of the present disclosure.

FIG. 6 depicts an exemplary schematic diagram of updated visual data with a determined visualization format, in accordance with embodiments of the present disclosure.

FIG. 7 is a flow-diagram illustrating a computer-implemented method of visual data creation in a web conference, in accordance with embodiments of the present disclosure.

### DETAILED DESCRIPTION

Aspects of the present disclosure relate to web conferences, and more specifically, to web conference data visualization. While the present disclosure is not necessarily limited to such applications, various aspects of the disclosure can be appreciated through a discussion of various examples using this context.

Web conferencing software facilitates communication between individuals online via transmission of audio/video (A/V) data of the individuals in real-time over a network. Web conferencing offers real-time point-to-point communications from one sender to many receivers. Web conference services allow text, audio, and/or video data to be shared simultaneously across geographically dispersed locations. Though web conferences have increased the ability for individuals to communicate in real-time, there are still improvements that need to be made.

In web conference environments, there is a need to deliver data to participants efficiently. Caption and transcription services are some of the most recent practical additions to web conference portals. However, caption or transcription information converted from audio data may only be rendered to the participants in a plain format, which makes it difficult for participants to extract useful information. Further still, participants may not receive any comprehensive review of topics discussed during a web conference. For example, text captions may be pushed to the participants over time, but these text captions do not visually illustrate the topics discussed in the conference. Additionally, recordings of the web conference can be presented to participants at a later time with system-generated transcripts. However, it is time consuming to review recording transcripts and the transcripts may contain errors. Currently, there is no efficient approach to deliver visual data within a proper visualization format to illustrate topics discussed in a web conference comprehensively.

In view of the above, there exists a need for augmented visual data creation to deliver visual data within a proper visualization format to participants of a web conference.

Embodiments of the present disclosure aim to solve technical problems described above, and propose a method, system, and computer program product for visual data creation in web conferences based on the conference types and associated visualization formats.

In embodiments, the conference type (such as a root-cause analysis conference, a problem determination conference, a task assignment conference, a technical discussion conference, etc.) can be identified based on various type-related information acquired from the conference and predefined type templates. This can be completed such that a proper visualization format can be determined from a plurality of predefined visualization formats (e.g., a table, a flowchart, a histogram, a mind map, etc.) to match the identified conference type. Accordingly, key information required by the determined visualization format can be extracted by monitoring the conference. Visual data can be created by populating the extracted key information into the determined visualization format. In this way, the visual data can be created within a proper visualization format that is suitable for the conference type, which can then be delivered to the participants of the conference (e.g., in an intuitively understandable manner). Accordingly, the topics discussed in the online conference can be visualized (e.g., conveniently, accurately, and comprehensively) during the conference in real-time. This can avoid cumbersome reviews currently experienced by web conference users such as manual review of captions and/or transcripts associated with web conferences.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as web conference data visualization management code 150. In addition, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data visualization management code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

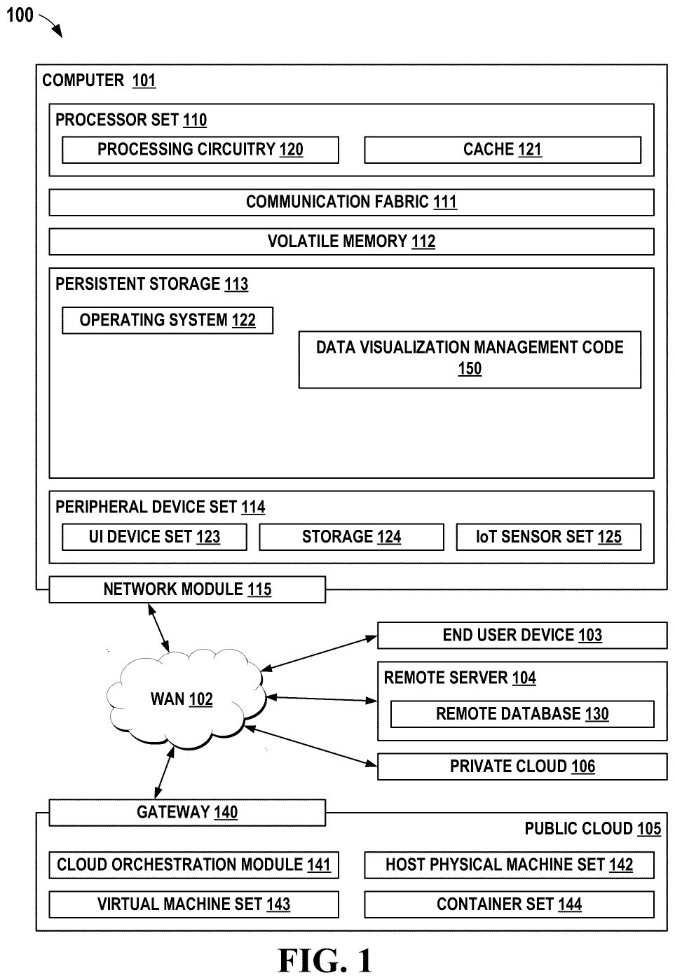

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some or all of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in data visualization management code 150 in persistent storage 113.

Communication fabric 111 includes the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in data visualization management code 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, mixed reality (MR) headset, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is understood that the computing environment 100 in FIG. 1 is only provided for illustration purpose without suggesting any limitation to any embodiment of this disclosure, for example, at least part of the program code involved in performing the inventive methods could be loaded in cache 121, volatile memory 112 or stored in other storage (e.g., storage 124) of the computer 101, or at least part of the program code involved in performing the inventive methods could be stored in other local or/and remote computing environment and be loaded when need. For another example, the peripheral device 114 could also be implemented by an independent peripheral device connected to the computer 101 through an interface. For a further example, the WAN may be replaced and/or supplemented by any other connection made to an external computer (for example, through the Internet using an Internet Service Provider).

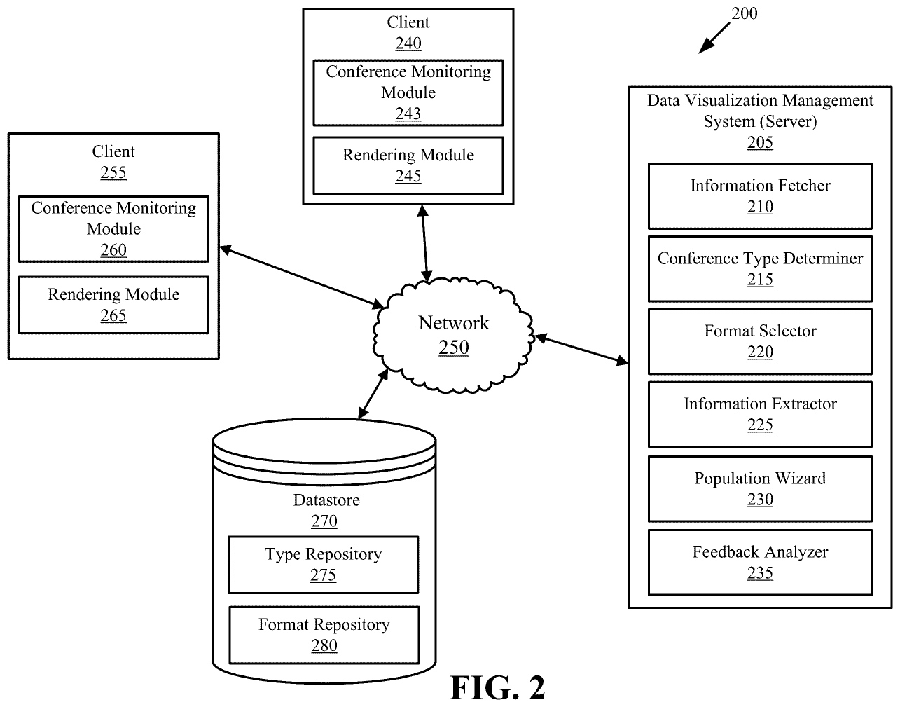

Turning now to FIG. 2, shown is a block diagram illustrating an example computing environment 200 in which illustrative embodiments of the present disclosure can be implemented. Computing environment 200 includes a data visualization management system 205 (also referred to as server 205), a client 240 (also referred to as a first computing device), a client 255 (also referred to as a second computing device), and a datastore 270. The data visualization management system 205, client 240, client 255, and datastore can be distant from each other and communicate over a network 250. The network 250 can be the same as, or substantially similar to, WAN 102 described with respect to FIG. 1. In embodiments, network 250 can be a local area network (LAN) or any other suitable network topology (e.g., peer-to-peer).

Server 205 can be any computing device that is used and controlled by a web conference service provider (for example, an enterprise or platform that provides web conference services) and may take any of the forms discussed above in connection with computer 101. For example, server 205 can coordinate and control audio and video transmission among multiple participants of a web conference to enable real-time communication over the network. Server 205 can also be responsible for storing and managing user profiles and other conference-related information and delivering visual data to participants of each conference within a proper visualization format, described in further detail below. Server 205 can include or interface web conference software (not shown). The web conference software can be application based, browser based, operating system (OS) based, etc. Web conference software can allow clients 240 and 255 to transfer textual, audio, and/or video data in real-time over network 250.

Each of clients 240 and 255 can be any computing device that is used and controlled by an end user (for example, a customer of a web conference service) to participate in an online conference and may take any of the forms discussed above in connection with EUD 103. Each of clients 240 and 255 can monitor a respective participant of the conference and upload audio data, video data, and other conference-related material from the participant to server 205 via network 250. Each of clients 240 and 255 can also receive audio data, video data, and other material from other participants via network 250 along with the augmented visual data created by server 205, and then render the received visual data, described in further detail hereinafter. It should be noted that although FIG. 2 only illustrates two clients within computing environment 200, any number of client devices can be implemented without departing from the spirit and scope of the present disclosure.

The datastore 270 includes a type repository 275 and a format repository 280. The datastore 270 can be any database that serves data and/or functionality to server 205. For example, type repository 275 can store a plurality of predefined type templates of different conference types, which may be useful for identifying the type of an ongoing web conference. Format repository 280 can store a plurality of predefined visualization formats corresponding to the different conference types, which may be useful for determining a proper format for visualizing the topics of the web conference. Accordingly, in order to create visual data with a visualization format that matches the conference type in real-time, server 205 may access and/or query type repository 275 and format repository 280 via network 250 to enhance the web conference.

As shown in FIG. 2, data visualization management system 205 can include an information fetcher 210, a conference type determiner 215, a format selector 220, an information extractor 225, a population wizard 230, and a feedback analyzer 235. The functionalities of the information fetcher 210, conference type determiner 215, format selector 220, information extractor 225, population wizard 230, and feedback analyzer 235 can be processor-executable instructions that can be executed by a dedicated or shared processor using received inputs.

Client 240 can include a conference monitoring module 243 and a rendering module 245. Likewise, client 255 can include a conference monitoring module 260 and a rendering module 265. Server 205 and clients 240 and/or 255 can work cooperatively to support augmented visual data creation services in web conferences. Details of the functions of the components within server 205, client 240, and client 255 will be described hereinafter.

Information fetcher 210 can be configured to acquire type-related information of a web conference. Information fetcher 210 can acquire the type-related information for identifying the conference type in various ways.

In some embodiments, information fetcher 210 can be configured to acquire the type-related information of the conference from arrangement information of the conference, such as conference topic, conference agenda, date and time, and/or attendees of the conference input by the organizer (e.g., administrator or host) when scheduling the conference.

In embodiments, information fetcher 210 can be configured to acquire the type-related information of the conference from hint information input by one or more participants of the conference. For example, the hint information related to the conference type (e.g., keywords of the topics to be discussed in the conference) may be provided by the participants of the conference actively or when required by server 205.

In embodiments, information fetcher 210 can be configured to acquire the type-related information of the conference from the raw data of the conference. The raw data of the conference can be any original data generated during the conference, which may be acquired by recording the conference, and may include audio data and/or video data collected from the participants of the conference, slides, and other documentation shared by the participants during the conference, and/or text information input by the participants in chat windows. The raw data may be used independently or in combination with the arrangement information and/or the hint information to generate the type-related information. For example, semantic recognition technology can be used to acquire the type-related information for the raw data such as audio data.

Conference type determiner 215 can be configured to identify a conference type of the conference based on the acquired type-related information of the conference and type templates stored in a type repository, such as type repository 275. In embodiments, conference type determiner 215 can be configured to identify the conference type by comparing the acquired type-related information with the predetermined type-related information in the stored type templates (e.g., of type repository 275) to determine if there is a match. Accordingly, conference type determiner 215 can identify the matched type template as the conference type of the conference, such as a root-cause analysis conference, a problem determination conference, a task assignment conference, an academic discussion conference, etc. Any suitable conference type can be implemented without departing from the spirit and scope of the present disclosure.

For example, conference type determiner 215 can identify a periodically recurring (e.g., daily, weekly, or monthly) conference as a “product optimization conference” that is regularly scheduled before a product is put into the market based on a match of the arrangement information with the predetermined type-related information in the type template of “product optimization conference”, such as a fixed group of participants or a regularly scheduled date and time for the conference. Additionally or alternatively, conference type determiner 215 can identify the conference type based on a match of the hint information and/or the raw data of the conference with the predetermined type-related information in the type templates stored in the type repository 275.

Format selector 220 can be configured to determine a visualization format from a plurality of visualization formats stored in a format repository (such as format repository 280) based on the identified conference type. For each of a plurality of conference types, the format repository 280 can store one or more predefined visualization format(s) that is/are suitable for presenting visual data of the topics discussed in the conference type. For example, a table format may be suitable for visually illustrating the topics of a first conference type, a flowchart format may be suitable for visually illustrating the topics of a second conference type, a histogram format may be suitable for visually illustrating the topics of a third conference type, a mind map format may be suitable for visually illustrating the topics of a fourth conference type, etc. The visualization formats may be stored in association with respective conference types within the format repository 280. Accordingly, format selector 220 can be configured to determine the proper visualization format from the plurality of visualization formats based on its mapping or association with the identified conference type.

It should be noted that the visualization formats described in the present disclosure may be of various types of graphical representations of information and data discussed during a web conference, which may provide an accessible way to view and understand the topics discussed in the conference, and the above-mentioned visualization formats (e.g., table, flowchart, histogram, and mind map) are only examples. Other visualization formats can also be contemplated to visualize the topics discussed in a web conference conveniently and comprehensively. The present disclosure does not restrict the types of the visualization formats stored in the format repository 280.

It should be noted that the plurality of visualization formats may be stored in the format repository in various levels of detail. Taking the visualization format “table” as an example, “table” may be pre-stored in the format repository 280 as a commonly used categories of visualization formats without any details, which may simply indicate the selection of a table format instead of other categories such as a flowchart, a histogram, or other visualization format. In another example, the visualization format “table” may be in a rough format with information only related to a predefined number of rows/columns of the table. In yet another example, the visual format “table” may be in a fine format with information related to a predefined number of rows/columns of the table as well as information related to the table title and column/row names (e.g., partially or fully prepopulated). It is contemplated that the visualization formats of different levels of detail may be stored in the format repository 280 such that a visualization format of desired level of detail may be selected and rendered to the participants. The present disclosure does not restrict the information prepopulated in the visualization formats in the format repository 280.

It is contemplated that the visualization format retrieved from the format repository 280 can be updated to match the discussed topics more suitably as the conference is continuously monitored and more details of the conference are captured. For any visualization format of a given level of detail, the video data, audio data, and/or chat data collected from the monitored conference may be used to enrich the retrieved visualization format such that the visualization format better reflects the topics of the current conference. For example, for a product optimization conference, a table may be determined as the proper visualization format, which may be stored in the format repository 280 with basic information prepopulated in the table. However, a product name or product version required to be populated in the table title may be left empty in the visualization format in the format repository 280. In this instance, the product name or version can be determined from the raw data of the conference generated during the conference (for example, by via speech/text recognition technology) and updated to the retrieved visualization format as the conference proceeds, and the updated visualization format may be stored into the format repository 280.

Information extractor 225 can be configured to extract key information required by the determined visualization format from raw data of the conference. For example, information extractor 225 can apply natural language processing (NLP) to the text converted from the video data or audio data of the conference as well as the text contained in the documentation or chat windows, such that the key information (such as keywords, semantic meanings, sentiments, and syntaxes) can be extracted from the text. NLP techniques that can be used to perform one or more functionalities referenced herein include, among others, morphological analysis (e.g., lemmatization, segmentation, part-of-speech tagging, stemming, etc.), syntactic analysis (e.g., parsing, sentence breaking, etc.), semantic analysis (e.g., named entity recognition (NER), terminology extraction, sentiment analysis, entity linking, etc.), and text classification.

In embodiments, when the visualization format comprises a table, the key information required by the visualization format may comprise a table title and content to be populated in each cell of the table. For example, the table may be used for summarizing roles and responsibilities for a product. In this example, the key information required by the table may include the product version to be populated in the table title, and may also include names, titles, and responsibilities of each member of the product team to be populated in each cell of the table.

In embodiments, when the visualization format comprises a flowchart, the key information required by the visualization format may comprise a flowchart title and node content of the flowchart. For example, the flowchart may be used for highlighting a solution to fix bugs of a software product. In this example, the key information required by the flowchart may include the product version to be populated in the flowchart title. Additionally, the software product may include a plurality of sub-routines, and thus the solution to fix the bugs of the product may be highly related to the dependencies between the sub-routines. For example, the actions required to fix the bugs may be checking Sub-Routine A first, checking Sub-Routine B next, then checking Sub-Routine C, . . . . , and finally checking Sub-Routine Z, based on the dependencies between the sub-routines. Accordingly, the key information required by the table may further include the names of the sub-routines of the product and their dependence relationships to be populated as node content of the flowchart.

Population wizard 230 may be configured to create visual data within the determined visualization format by populating the extracted key information into the determined visualization format. In an embodiment, the key information required by the determined visualization format may be extracted from the raw data of the web conference and be populated into the visualization format in real-time, such that more details of the conference can be included in the created visual data as the conference proceeds and the participants are kept up to date with the latest discussion topics.

It should be noted that server 205 may include more components than those shown in FIG. 2. For example, server 205 may include a transceiver (not shown), which can be configured to transmit the visual data within the determined visualization format to a computing device (such as clients 240 and 255) of a participant of the conference for rendering the visual data.

Conference monitoring modules 243 and 260 can be configured to monitor interactive actions performed by respective participants of the conference at clients 240 and 255, respectively, and provide the action data (e.g., audio data of respective participants) to server 205. In addition, rendering agents 245 and 265 can be configured to render the visual data created by server 205 within the determined visualization format to respective participants of the conference at clients 240 and 255, respectively, such that the participants may have a comprehensive view of the topics discussed in the conference in real-time.

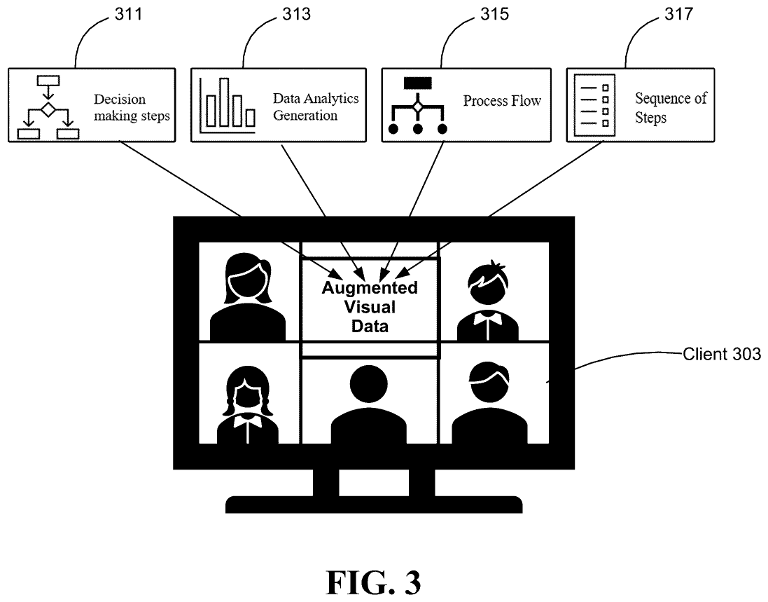

FIG. 3 depicts an exemplary schematic diagram of visual data presentation in a web conference, in accordance with embodiments of the present disclosure. As shown in the exemplary layout of the graphic user interface (GUI) of the web conference, a 3×2 grid screen is rendered to a participant of the conference, such as on a display of client 303 (e.g., clients 240 or 255). Specifically, the frames of five attendees and the augmented visual data created by the server of the web conference are shown on the 3×2 grid screen. In addition, the augmented visual data rendered at the client can match the current conference type so as to visually illustrate the topics discussed in the conference. As shown in FIG. 3, the visual data may be rendered within the visualization format related to one or more of decision-making steps 311, data analytics generation 313, process flow 315, sequence of steps 317, or another format. It should be noted that the layout of FIG. 3 is only an example, and the augmented visual data created with the proper visualization format can be rendered at any locations of the graphic user interface and in various styles.

As an illustrative example described in combination with FIG. 2 and FIG. 3, if a software product malfunctions, various individuals may attend a meeting through any suitable web conference service or platform to begin formulating solutions for fixing the software product. During the web conference, leaders, engineers, architects, technicians, and/or administrators from various teams (for example, operating system, database, application server, network, etc.) can interact in the web conference, such as the five attendees shown in FIG. 3.

In this illustrative scenario, server 205, for example by information fetcher 210, can acquire the type-related information from the arrangement information contained in an invitation email of the scheduled conference, such as the conference topic and details of the participants and their teams. Server 205 can also prompt the participants to enter the hint information to help in identifying the conference type, such as keywords of “fix software defects”. Additionally or alternatively, participants may also voluntarily enter the hint information such that information server 205 may better identify the conference type. Additionally or alternatively, server 205 can monitor the conference for a period of time and acquire the type-related information by parsing the monitored raw data of the conference, such as video and audio data, documentation, and chat history.

Next, server 205, for example by conference type determiner 215, can identify the conference type using pre-defined conference templates. For example, based on a match of the type-related information and the pre-defined information in a particular conference template of “root-cause analysis meeting”, server 205 can identify the conference as a root-cause analysis meeting.

Additionally, server 205, for example by format selector 220, can select a suitable visualization format for the identified type of the conference. As the web conference is pertains to root cause analysis, a detailed step-by-step flow chart may be useful for indicating which software to check, which sub-routines of the software to check, and the order of the checking operations, etc. Therefore, a visualization format of flowchart may be selected. The selection of the visualization format may be selected by comparing the identified conference type with the conference types associated with the visualization formats. Next, server 205, for example by information extractor 225, can extract key information required by the visualization format from the raw data of the conference by ascertaining the key components (such as sub-routines) and the relationship between the key components of the software product.

Thereafter, server 205, for example by population wizard 230, can create the visual data by populating the extracted key information into the selected visualization format, such that the visual data can be rendered to the participants of the conference, as shown in FIG. 3. For example, a detailed sequence of multiple steps in a flowchart that depict where the issue originates and the actions that can be taken to address the issue may be created and shared across the participants of the conference to provide a clear visual description of the actions to be taken to fix the bugs of the software product.

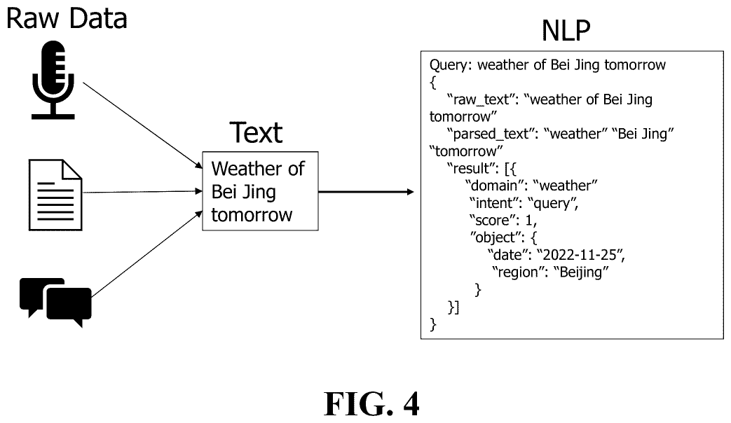

FIG. 4 depicts an exemplary schematic diagram of extracting key information from raw data of a web conference, in accordance with embodiments of the present disclosure. In this example, natural language processing (NLP) is described as an exemplary information extraction technique to extract the key information from raw data of a web conference. Any of the NLP techniques discussed with respect to FIG. 2 can be implemented. As shown in FIG. 4, once a visualization format that matches the current conference type is determined from a plurality of visualization formats, key information required by the determined visualization format can be extracted from the raw data of the conference. Specifically, text data, such as “Weather of Beijing tomorrow”, can be obtained from the raw data of the conference (e.g., audio data of the participants collected by the microphones of the clients, slides and/or other documentation shared by the participants during the conference, and/or the chat data of chat window(s) of the GUI of the web conference). Next, NLP can be performed to parse the obtained text data to extract key information from the text data, which can be populated in the determined visualization format. In this example, based on the parsing of the raw data of the conference, it can be determined that the current topic discussed in the conference is related to weather, the region of interest is Beijing, and the date of interest is tomorrow (e.g., Nov. 25, 2022). Accordingly, the extracted key data, such as the retrieved weather information of Beijing tomorrow, can be populated in the visualization format where appropriate. It can be contemplated that any other information extraction methods based on machine learning (ML) or artificial intelligence (AI) may be used to extract the required key information.

It should be noted that one determined visualization format can be commonly applied to each of the participants of conference such that each participant views the visual data with the same visualization format. However, in embodiments of the present disclosure, two or more visualization formats can be determined for the current conference type such that visual data created with different visualization formats can be rendered to different participants of the conference. For example, the same data can be presented in two different visualization formats for two respective participants within the web conference. A particular visualization format to be selected for a participant, can, in embodiments, be determined based on preferences associated with each participant (e.g., within configuration settings of web conference software).

In embodiments, the determined visualization format may comprise a first visualization format and a second visualization format. Accordingly, the server (such as server 205) can transmit the visual data with the first visualization format to a first computing device (such as client 240) of a first participant of the conference for rendering the visual data with the first visualization format. Likewise, the server (such as server 205) can transmit the visual data with the second visualization format to a second computing device (such as client 255) of a second participant of the conference for rendering the visual data with the second visualization format. Although two visualization formats are described in the embodiment, it is contemplated that more than two different visualization formats can be used for creating the visual data and rendered to different participants depending the preferences of the participants.

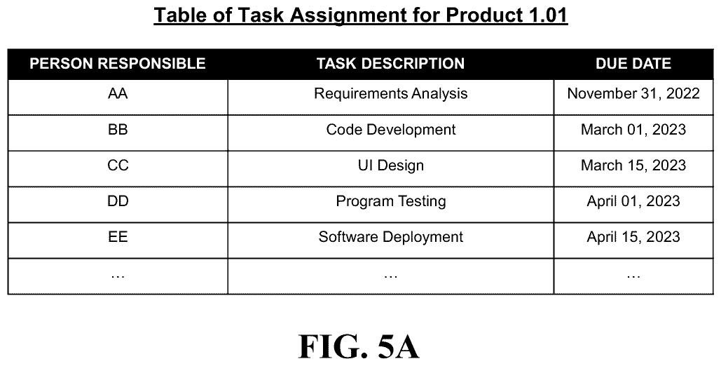

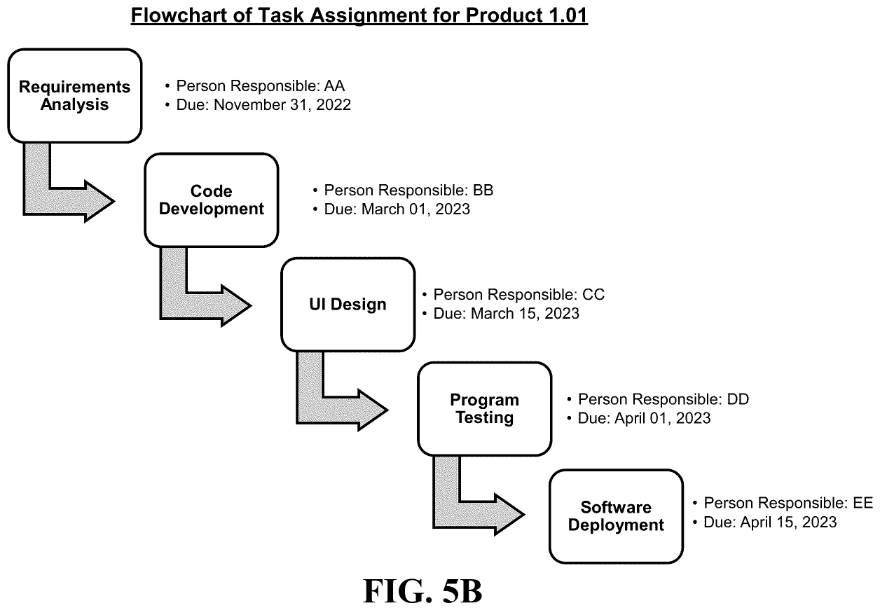

FIG. 5A and FIG. 5B depict exemplary schematic diagrams of visual data created with different visualization formats in a given web conference, in accordance with embodiments of the present disclosure. As an illustrative example, the web conference may be related to a task assignment for a software product, and the individuals responsible for each task and their respective due dates are to be discussed during the web conference. In this scenario, the product manager may prefer to view the visual data in a simple format such as a table. As shown in FIG. 5A, the table is shown to include the table title of “Table of Task Assignment for Product 1.01,” column names of “person responsible,” “task description,” and “due date,” and content populated in each cell of the table. By contrast, other members of the product team may prefer viewing the visual data in an action-based flowchart such that they can clearly view the chronological order of the assigned tasks and how to cooperatively work with other members to accomplish the development of the product.

As shown in FIG. 5B, the flowchart includes the flowchart title of “Flowchart of Task Assignment for Product 1.01,” node content of “Requirements Analysis,” “Code Development,” “UI Design,” “Program Testing,” and “Software Deployment,” and the chronological order thereof. Other information can also be rendered in each node.

As mentioned above in connection with FIG. 2, the determined visualization format may be adjusted based on the information (such as video, audio, and chat data) collected from the monitored conference in a self-adaptive manner, such that the visual data within the determined visualization format may be updated to better reflect the topics of the current conference. For example, the visual data may initially be rendered to the participants with the visualization format retrieved from the format repository, such as a table with a predefined number of rows/columns. However, as the conference is monitored and recorded continuously, the server may determine that more rows/columns should be inserted into the table to better reflect the topics currently discussed in the conference, for example, by parsing the audio data of the participants using recognition (e.g., speech/text) technology. In this example, the retrieved visualization format may be updated to include additional rows/columns, and accordingly, the visual data may be rendered within the updated format to the participants of the conference. Additionally or alternatively, the visual data within the determined visualization format may be updated based on feedback information provided by the participants of the conference.

Referring back to FIG. 2, server 205 may include feedback analyzer 235. In embodiments, feedback analyzer 235 may use feedback information from participants to enhance data visualization management. The participants may provide feedback in various manners. For example, a button, an icon, or other GUI element may be displayed on the GUI of the online conference, such as the GUI as shown in FIG. 3, through which the participants may input their feedback on the visual data within the determined visualization format interacting with these GUI elements. In embodiments, the server may obtain the feedback information from the participant by capturing and analyzing the expressions or emotions of the participants (e.g., via sentiment detection and recognition technology). In embodiments, the server may obtain the feedback information by monitoring suggestions on the visualization format spoken by the participants. In embodiments, the server may obtain the feedback information by receiving manual corrections to the rendered visualization format by a participant, such as the conference organizer who is authorized to modify the visualization format using an editing tool provided in the GUI.

In an embodiment, feedback analyzer 235 can be configured to receive feedback information on the visual data within the determined visualization format, and then update the visual data within the determined visualization format based on the feedback information.

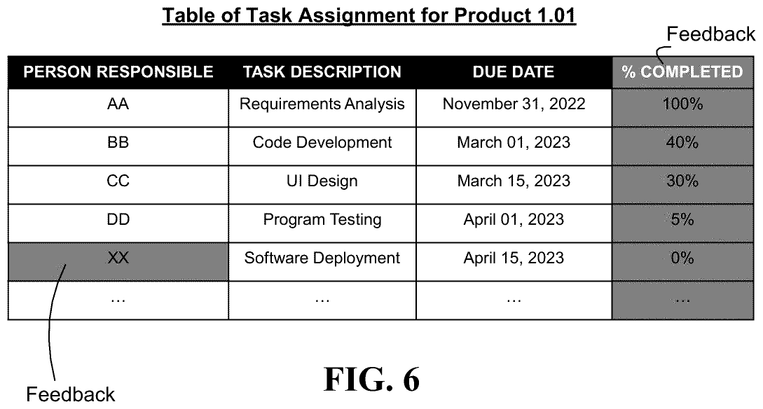

FIG. 6 depicts an exemplary schematic diagram of updated visual data within the determined visualization format according to an embodiment of the present disclosure, which includes revisions to the visual data as shown in FIG. 5A.

As shown in FIG. 5A, the person responsible for the task of software deployment may be inadvertently recognized as “EE” and rendered to the participants. In this case, any participant of the web conference may provide feedback on this error (e.g., including the correct result). For example, as mentioned above, the participant may provide their suggestion on the visualization format through a voice command or through a UI element displayed on the graphic user interface of the conference. Accordingly, server 205, for example by feedback analyzer 235, may analyze the feedback information and correct the person responsible for software deployment as “XX”, as shown in FIG. 6.

As another example, as shown in FIG. 5A, the table of task assignment may be rendered to the participants of the conference with three columns. However, it may be beneficial to show the progress of each task such that the participants may have a clear understanding of the schedule of the product. In this case, a participant of the conference may provide feedback that adding a column of the progress of each task may be beneficial. Accordingly, server 205, for example by feedback analyzer 235, may analyze the feedback information and adds a column of “% COMPLETED” in the table to refine the visual data, as shown in FIG. 6.

In another embodiment, feedback analyzer 235 may be configured to receive feedback information on the visual data within the determined visualization format, and then update the determined visualization format in the format repository (such as format repository 280) based on the feedback information.

As mentioned above in connection with FIG. 2, format repository 280 may store a plurality of predefined visualization formats corresponding to different conference types. Those predefined visualization formats may be updated according to feedback information. Accordingly, when a participant of the conference provides feedback related to the visual data rendered within the visualization format for the current conference, the feedback may be used to update the visualization format stored in the format repository 280 for future use. For example, the feedback that adding a column of the progress of each task may be beneficial as described in FIG. 6 may be used to update the visualization format stored in the format repository 280 with this newly added column.

It should be noted that although the visual data within the determined visualization format is described as being presented to participants in real-time during the conference, it may also be presented to the participants after the conference. Specifically, server 205 may maintain a data structure that collects, saves, updates, and tracks the conference-related data of each conference, such as the video and audio data, chat data, and the visual data collected or created during the conference. Accordingly, any participant or other team members who missed the conference may watch a video session that has been recorded along with the created visual data.

It should be noted that the approach of visual data creation in an online conference can be implemented in various manners. In an embodiment of the present disclosure, the approach of visual data creation in a web conference is implemented via microservice. In embodiments, the online conference service can be installed in the server 205 and clients 240 and 255 as an independent service that communicates with other functions operating on the server 205 and clients 240 and 255 over well-defined application program interfaces (APIs). Microservice architectures can make the online conference service or platform easier to scale and faster to develop, enabling innovation and accelerating time-to-market for new features.

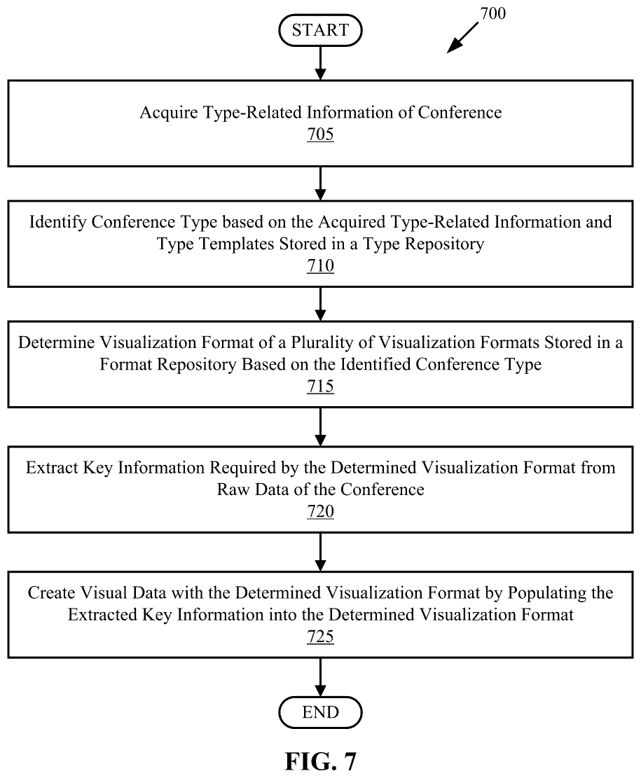

FIG. 7 is a flow-diagram depicting an example computer-implemented method 700 of visual data creation in an online conference, in accordance with embodiments of the present disclosure. One or more operations of method 700 can be completed by one or more computing devices (e.g., computer 101, server 205, clients 240 and 255, client 303, etc.). The detailed description of method 700 can refer to the elements described above with respect to FIGS. 1-6. For example, method 700 can be executed by the architecture for visual data creation in web conferences as described with respect to FIG. 2. Each operation of method 700 can be performed by one or more processing units, such as central processing unit (CPU).

Method 700 includes operations 705-725. At operation 705, type-related information of the conference can be acquired. Acquiring type-related information of the conference can comprise acquiring the type-related information of the conference from arrangement information of the conference. Acquiring type-related information of the conference can comprise acquiring the type-related information of the conference from hint information input by one or more participants of the conference. Acquiring type-related information of the conference can also comprise acquiring the type-related information of the conference from the raw data of the conference.

At operation 710, a conference type of the conference can be identified based on the acquired type-related information of the conference and type templates stored in a type repository, such as type repository 275 of FIG. 2.

At operation 715, a visualization format can be determined from a plurality of visualization formats stored in a format repository (such as format repository 280 as shown in FIG. 2) based on the identified conference type. The visualization format can vary. For example the visualization format can be a table, flow-chart, graph, or other visual representation.

At operation 720, key information required by the determined visualization format can be extracted from raw data of the web conference. For example, when the visualization format comprises a table, the key information can comprise a table title and content to be populated each cell of the table. As another example, when the visualization format comprises a flowchart, the key information comprises a flowchart title and node content of the flowchart.

At operation 725, visual data can be created within the determined visualization format by populating the extracted key information into the determined visualization format.

Method 700 can also comprise an operation of transmitting, by one or more processing units, the visual data within the determined visualization format to a computing device of a participant of the conference for rendering the visual data.

In an embodiment of the present disclosure, the determined visualization format comprises a first visualization format and a second visualization format. In this embodiment, method 700 can further comprise an operation of transmitting the visual data with the first visualization format to a first computing device of a first participant of the conference for rendering the visual data with the first visualization format, and an operation of transmitting the visual data with the second visualization format to a second device of a second participant of the conference for rendering the visual data with the second visualization format.

Method 700 can also comprise an operation of receiving feedback information on the visual data within the determined visualization format, and an operation of updating the visual data within the determined visualization format based on the feedback information.

Method 700 can also comprise an operation of receiving feedback information on the visual data within the determined visualization format, and an operation of updating the determined visualization format in the format repository based on the feedback information.

In embodiments, method 700 for visual data creation in a web conference can be implemented via microservice.

The aforementioned operations can be completed in any order and are not limited to those described. Additionally, some, all, or none of the aforementioned operations can be completed, while still remaining within the spirit and scope of the present disclosure.

As discussed in more detail herein, it is contemplated that some or all of the operations of some of the embodiments of methods described herein can be performed in alternative orders or may not be performed at all; furthermore, multiple operations can occur at the same time or as an internal part of a larger process.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession may in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used, and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method for visual data creation in a web conference comprising:
acquiring, by one or more processing units, type-related information of the web conference;
identifying, by one or more processing units, a conference type of the web conference based on the acquired type-related information of the web conference and type templates stored in a type repository;
determining, by one or more processing units, a visualization format from a plurality of visualization formats stored in a format repository based on the identified conference type;
extracting, by one or more processing units, key information required by the determined visualization format from raw data of the web conference; and
creating, by one or more processing units, visual data within the determined visualization format by populating the extracted key information into the determined visualization format.

2. The computer-implemented method of claim 1, further comprising:
transmitting, by one or more processing units, the visual data within the determined visualization format to a computing device of a participant of the web conference for rendering the visual data.

3. The computer-implemented method of claim 1, wherein the determined visualization format comprises a first visualization format and a second visualization format, and the method further comprises:
transmitting, by one or more processing units, the visual data within the first visualization format to a first computing device of a first participant of the web conference for rendering the visual data within the first visualization format; and
transmitting, by one or more processing units, the visual data within the second visualization format to a second computing device of a second participant of the web conference for rendering the visual data within the second visualization format.

4. The computer-implemented method of claim 1, wherein the acquiring type-related information of the web conference comprises:
acquiring, by one or more processing units, the type-related information of the web conference from arrangement information of the web conference.

5. The computer-implemented method of claim 1, further comprising:
receiving, by one or more processing units, feedback information on the visual data within the determined visualization format; and
updating, by one or more processing units, the visual data within the determined visualization format based on the feedback information.

6. The computer-implemented method of claim 1, further comprising:
receiving, by one or more processing units, feedback information on the visual data within the determined visualization format; and
updating, by one or more processing units, the determined visualization format in the format repository based on the feedback information.

7. The computer-implemented method of claim 1, wherein the visualization format is selected from a group consisting of: a table, a flowchart, a histogram, and a mind map.

8. The computer-implemented method of claim 1, wherein the computer-implemented method for visual data creation in the web conference is implemented via microservice.

9. A system for visual data creation in an online conference, comprising:
one or more processors; and
one or more computer-readable storage media collectively storing program instructions which, when executed by the one or more processors, are configured to cause the one or more processors to perform a method for visual data creation in a web conference comprising:
acquiring type-related information of the web conference;
identifying a conference type of the web conference based on the acquired type-related information of the web conference and type templates stored in a type repository;
determining a visualization format from a plurality of visualization formats stored in a format repository based on the identified conference type;
extracting key information required by the determined visualization format from raw data of the web conference; and
creating visual data within the determined visualization format by populating the extracted key information into the determined visualization format.

10. The system of claim 9, wherein the method performed by the one or more processors further comprises:
transmitting the visual data within the determined visualization format to a computing device of a participant of the web conference for rendering the visual data.

11. The system of claim 9, wherein the determined visualization format comprises a first visualization format and a second visualization format, and where the method performed by the one or more processors further comprises:
transmitting the visual data within the first visualization format to a first computing device of a first participant of the web conference for rendering the visual data within the first visualization format; and
transmitting the visual data within the second visualization format to a second computing device of a second participant of the web conference for rendering the visual data within the second visualization format.

12. The system of claim 9, wherein the acquiring type-related information of the web conference comprises:
acquiring the type-related information of the web conference from hint information input by one or more participants of the web conference.

13. The system of claim 9, wherein the method performed by the one or more processors further comprises:
receiving feedback information on the visual data within the determined visualization format; and
updating the visual data within the determined visualization format based on the feedback information.

14. The system of claim 9, wherein the method performed by the one or more processors further comprises:
receiving feedback information on the visual data within the determined visualization format; and
updating the determined visualization format in the format repository based on the feedback information.

15. The system of claim 9, wherein the visualization format is selected from a group consisting of: a table, a flowchart, a histogram, and a mind map.

16. The system of claim 9, wherein the system for visual data creation in the web conference is implemented via microservice.

17. A computer program product comprising one or more computer readable storage media, and program instructions collectively stored on the one or more computer readable storage media, the program instructions comprising instructions configured to cause one or more processors to perform a method for visual data creation in a web conference comprising:
acquiring type-related information of the web conference;
identifying a conference type of the web conference based on the acquired type-related information of the web conference and type templates stored in a type repository;
determining a visualization format from a plurality of visualization formats stored in a format repository based on the identified conference type;
extracting key information required by the determined visualization format from raw data of the web conference; and
creating visual data within the determined visualization format by populating the extracted key information into the determined visualization format.

18. The computer program product of claim 17, wherein the method performed by the one or more processors further comprises:
transmitting the visual data within the determined visualization format to a computing device of a participant of the web conference for rendering the visual data.

19. The computer program product of claim 17, wherein the determined visualization format comprises a first visualization format and a second visualization format, and where the method performed by the one or more processors further comprises:
transmitting the visual data within the first visualization format to a first computing device of a first participant of the web conference for rendering the visual data within the first visualization format; and
transmitting the visual data within the second visualization format to a second computing device of a second participant of the web conference for rendering the visual data within the second visualization format.

20. The computer program product of claim 17, wherein the method performed by the one or more processors further comprises:
receiving feedback information on the visual data within the determined visualization format; and
updating the visual data within the determined visualization format based on the feedback information.
